(19) United States
(12) Patent Application Publication
(10) Pub. No.: US 2017/0228500 A1
(43) Pub. Date: Aug. 10, 2017

(54) PROCESS OF GENERATING MEDICAL RECORDS

(71) Applicant: Justin Massengale, Brookline Village, MA (US)

(72) Inventor: Justin Massengale, Brookline Village, MA (US)

(21) Appl. No.: 15/428,399

(22) Filed: Feb. 9, 2017

Related U.S. Application Data
(60) Provisional application No. 62/293,238, filed on Feb. 9, 2016.
(60) Provisional application No. 62/293,234, filed on Feb. 9, 2016.

(51) Int. Cl. G06F 19/00; G06F 17/30

(52) U.S. Cl. CPC G06F 19/322; G06F 19/328; G06F 17/30663; G06F 17/30569

(57) ABSTRACT

A process includes creating a medical record to document a meeting between a patient and a medical professional. A database is created containing a number of key terms related to one or more of the following: ICD-10 billing codes; medical conditions; treatment; or diagnoses. The medical professional asks the patient a question. The question is converted into text. A number of key text terms are identified from the text by determining which words from the text match key terms from the database. The medical record is updated based on the key text terms. The medical professional then reviews the medical record and repeats the prior steps as necessary to complete the medical record.

### CROSS REFERENCE TO RELATED APPLICATION

This application is a U.S. non-provisional patent application which claims priority from U.S. Provisional Application for Patent No. 62/293,238 filed Feb. 9, 2016 and U.S. Provisional Application for Patent No. 62/293,234 filed Feb. 9, 2016, both of which are incorporated herein by reference.

### FIELD OF THE INVENTION

The subject disclosure relates to healthcare and more particularly to improved processes of generating medical records.

### BACKGROUND OF THE INVENTION

For every visit with a patient, a health care provider is required to generate a unique “note” documenting the visit, for incorporation into the patient's medical record. The note is required medico-legally, to serve as a record of what was discussed at the visit, and to provide a standardized method of communication between providers. Currently, the generation of the note is accomplished most often via one of two means: either by a transcription service, based on a spoken-word recording of the intended content of the note dictated by the provider, or by the provider directly, by typing the note's content into the computerized medical record at a terminal. Both methods come with compromises. Contracted medical transcription services cost providers money for each transcribed text line. The reports, which must then be edited for content by the provider, are often not available for such review until several days after their creation. Further, even more time has passed before they are available for other providers to reference. The manual entry of note text into the electronic health record also requires time both for navigation in the data entry application and actual text typing. This can result either in a skeletal note which sacrifices detail for brevity, or, at the other extreme, in a behemoth created when the note writer chooses to resort to simply compounding text portions of prior notes, lab data spreadsheets, and radiology reports with repeated copy-and-paste functions, thus obscuring potentially salient data in a morass of noise. A rapid, cheap and reliable means of generating informative and well-phrased visit documentation is therefore ever the more important in today's health care information age.

In addition to its descriptive function, the note is also used to assign billing codes to the visit for monetization purposes. From one set of codes, included in the International Classification of Diseases (ICD-10) database, one or more specific diagnoses must be chosen to represent the disease(s) that each visit addressed, based on an extensive published list of over 60,000 possible choices. From a different set, an Evaluation and Management (E&M) code must be selected to describe the complexity level of the visit in order to submit a charge to the payor (e.g., an insurance company). Codes must be assigned for each visit before reimbursement for the visit can be obtained.

The need for an expeditious and reliable means of code assignment is of utmost importance. As the dependence on computer based electronic health record systems (EHRs) increases, providers are being more and more frequently required to look up and select the code for a visit directly in the patient's computerized account. Although search tools for the codes exist within most commonly used EHRs, these steps consume already limited time which providers have to spend with patients, and can lead to poor scores in patient satisfaction measurements which are key for hospital business benchmarks and marketing. In addition, the computerized code data is visible to other providers in the form of a “problem list”. In this form, it is used as a quick summary of a patient's overall health, and can affect treatment decisions by other providers at other points of care.

Although the accuracy of these codes is clearly important to ensure that each patient-provider interaction is factually represented, the goal of consistently reliable code assignment for every visit with every patient presents several challenges. The limited time available for patient visits, combined with the non-intuitive nature of the code selection criteria, means that providers may be tempted to estimate the most appropriate selection, based on either past experience or recollection of the criteria or mere reliance on codes from prior visits, even when new diagnostic information or a more careful review could reveal that a different code is in fact more appropriate. This can set the stage for errors of overestimation or omission, the consequences of which can not only affect the accuracy of the information available to other providers and result in misinformed treatment decisions, but can have financial repercussions for providers and hospitals in terms of lost revenue or, even worse, audits and fines for billing fraud, if claimed codes and the documents used to justify them do not match.

### SUMMARY OF THE INVENTION

The subject disclosure overcomes the drawbacks of the prior art by providing a process that quickly and reliably assigns accurate medical codes to a patient visit, generates a reliable medical record, and improves patient treatment.

In one embodiment, the subject technology relates to a process of generating an appropriately phrased and formatted final medical record suitable for medico-legal documentation in standard clinical terminology. In some embodiments, at (I) a database containing a plurality of key terms related to ICD-10 billing codes and medical conditions is provided. At step (I)(a) a dialogue is created between a medical professional and a patient by the medical professional asking a plurality of questions to the patient and the patient providing a plurality of responses. At step (II) the dialogue is converted into text. At step (III) at least one key text term is identified from the text. In some embodiments, the key text terms are identified by comparing the text with the key terms of the database. At step (IV) at least one ICD-10 billing code which corresponds to the at least one key text term is identified. At step (V) a partially completed note is completed from the key text terms. The partially completed note can be created from the text by entering data terms related to the at least one key text terms, the at least one ICD-10 billing codes, and the at least one medical condition into a standard medical record form. At step (VI) at least one additional question is asked to the patient based on the at least one ICD-10 billing codes. At step (VII) at least one additional response is received from the patient to the at least one additional question. At step (VIII) the additional questions and additional responses into are converted additional text. At step (IX) additional key text terms from the additional text are identified. In some embodiments, the additional key text terms are identified by comparing the additional text with the key terms of the database. At step (X), the partially completed note is updated by adding information related to the additional key terms to the partially completed note.

In some embodiments, the process includes the additional step of (IV)(a) identifying at least one medical condition related to the at least one key text term. Further, some embodiments include step (VI)(a), asking at least one medical condition question to the patient based on the at least one medical condition. Further, the process may include step (VII)(a) receiving at least one medical condition response from the patient to the at least one medical condition question. The process may then include step (VIII) (a), converting the at least one medical condition question and the at least one medical condition response into additional text.

In some embodiments, at step (XI), steps (VI)-(X) may be repeated depending on whether the additional text corresponds with at least one ICD-10 billing code. In some embodiments, at step (XII), steps (VI)(a), (VII)(a), (VIII)(a), and (IX) may be repeated depending on whether the additional text corresponds to at least one new medical condition.

Additional steps are included in other embodiments. At step (XIII), the partially completed note is proofread for errors. At step (XIV) the partially completed note is approved to create a completed medical record. At step (XV) the highest allowable E&M level is calculated.

In some embodiments, the subject technology includes a process of creating a medical record to document a meeting between a patient and a medical professional. At process includes, at step (I) the medical professional asking a question to the patient. At step (II) the patient provides a response to the question. At step (III), the question and the response are converted into text. At step (IV), at least one key text term is identified from the text related to one of the following: ICD-10 billing codes; or medical conditions. At step (V), the medical record is updated based on the key text terms. The medical record may include a problem list and updating the medical record may include updating the problem list based on the key text terms. At step (VI), the medical professional reviews the medical record. At step (VII), steps (I) through (VI) are repeated until the medical professional determines that no additional information is required.

In some embodiments, the process may include additional steps. For example, step (VIII) involves again reviewing the medical record. The medical record can then be updated based on any errors or omissions at step (IX). At step (X) a treatment for the patient based is determined based on the completed medical record.

In some embodiments, the subject technology includes a different process of creating a medical record to document a meeting between a patient and a medical professional. In this process, at step (I) a database of key terms related to one or more of the following: ICD-10 billing codes; medical conditions; treatment; or diagnoses; is created. At step (II) the medical professional asks a question to the patient. At step (III) the question is converted into text. At step (IV) a number of key text terms from the text are identified by determining which words from the text match key terms from the database. At step (V) the medical record is updated based on the key text terms. The medical record may include a problem list that is updated based on the key text terms. In some embodiments, at step (V)(a), the text is run through a computer program to identify and delete key text terms which are not relevant. At step (VI) the medical professional reviews the medical record. At step (VII) steps (II) through (VI) are repeated until the medical professional determines that no additional information is required to complete the medical record. In some embodiments, at step (VIII) a treatment for the patient is determined based on the medical record.

### BRIEF DESCRIPTION OF THE DRAWINGS

So that those having ordinary skill in the art to which the disclosed system pertains will more readily understand how to make and use the same, reference may be had to the following drawings.

FIG. 1 is a flowchart showing a process in accordance with the subject technology.

FIG. 2 is a flowchart showing another process in accordance with the subject technology.

FIG. 3 is a block diagram showing a distributed computing environment for utilizing processes in accordance with the subject technology.

FIG. 4 is a block diagram of exemplary hardware particularly configured to perform a process in accordance with the subject technology.

### DETAILED DESCRIPTION OF PREFERRED EMBODIMENT

The subject technology overcomes many of the prior art problems associated with the generation of medical records. The advantages, and other features of the systems and methods disclosed herein, will become more readily apparent to those having ordinary skill in the art from the following detailed description of certain preferred embodiments taken in conjunction with the drawings which set forth representative embodiments of the present invention.

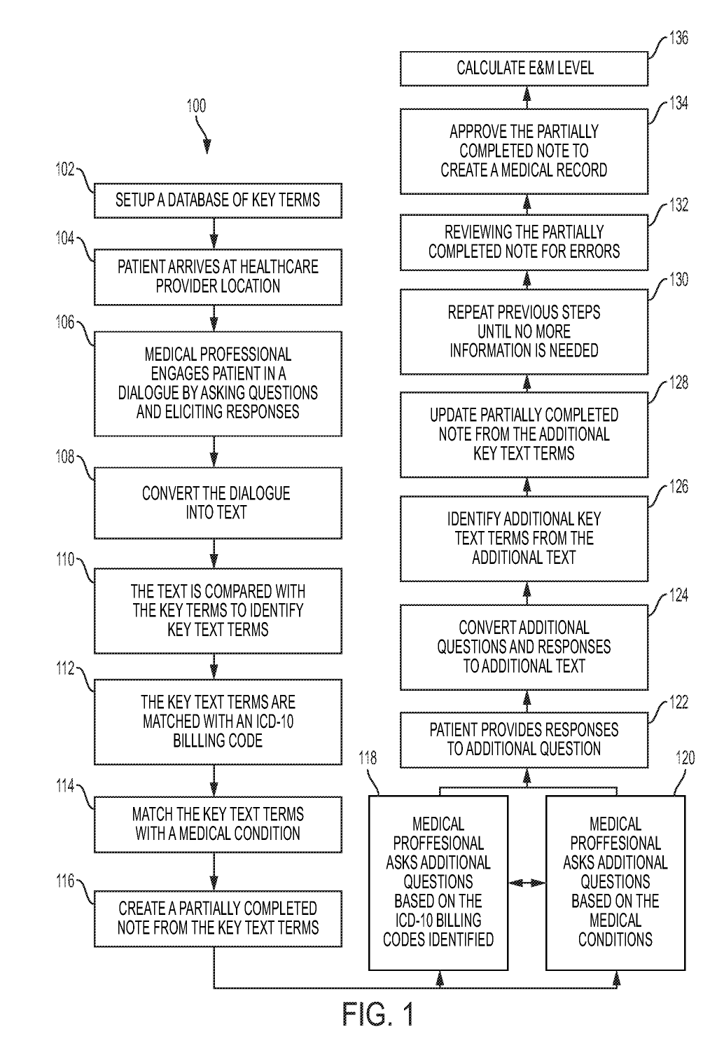

Referring now to FIG. 1, a process of the subject technology is shown generally at 100. The process 100 results in the generation of an appropriately phrased and formatted final medical record that is suitable for medico-legal documentation in standard clinical terminology. The process 100 starts at step 102 when a database is setup at the health care provider location that includes a number of relevant key terms to be used in assembling the medical record and treating the patient. The key terms may be related to treatment codes such as ICD-10 billing codes. ICD-10 billing codes can be helpful in classifying patient treatment, particularly for billing purposes. The key terms may likewise be related to more general medical conditions which correspond with certain conditions or treatment options. Ultimately, the key terms are terms that if identified in a given patient visit are helpful in medical diagnosis, treatment, reporting, and/or billing, and a medical professional may accordingly choose to include other terms in the database of key terms.

At step 104, a patient arrives at a healthcare provider location. The healthcare provider location could be a hospital, doctor's office, clinic, or any other location where healthcare services are administered. The healthcare provider location will have a number of working medical professionals, such as nurses, doctors, and physician's assistants, for example.

Eventually, the patient will meet with one of the medical professionals. At step 106, the medical professional engages the patient in a dialogue by asking questions. The medical professional may ask questions related to patient information, medical history, current symptoms, conditions giving rise to those symptoms, or any other topic germane to the patient's health or treatment thereof. The patient will then respond with answers to the questions, or possibly with addition related information.

As the dialogue between the patient and healthcare provider continues, the dialogue is converted to text at step 108. This can be accomplished by requiring the provider to wear a microphone. The microphone then captures the dialogue in real time during the visit and the dialogue can be transcribed by an automated speech to text tool into a text window. Alternatively, or additionally, a person can convert the dialogue into text by typing out the conversation or writing it down by hand.

At step 110, the text can be searched for key terms. The words in the text are compared to the key terms from the database, for example, by a person or computer. When a term from the text is found the match a key term from the database, a key text term has been identified. Other steps can be employed, as described in more detail below, to do a more thorough analysis of the text and make sure that only key terms related to clinically relevant information are extracted and/or relied upon. The key text terms are then matched up with an ICD-10 billing code at step 112 and/or a medical condition at step 114. The provider now has now identified relevant information which can be expanded upon during the medical visit. Using this relevant information, a partially completed note is created at step 116. The partially completed note is essentially a medical record which has not been completed, or which the medical professional has not confirmed is complete. The partially completed note can be written from scratch or, more preferably, can be a medical record template that is filled in as the key text terms identified from the visit are matched with the key terms from the database. For example, the medical record template might include a section entitled “symptoms.” As key terms related to symptoms are identified from the conversation, the “symptoms” section is filled in. Therefore, for example, if the patient mentions headaches and nausea, these can matchup with key terms from the database related to symptoms and can be entered into the partially completed note under the symptoms section. Further, a computer program, such as a Javascript software code tool can be employed to correctly process the text and key text terms and convert them into a format that is appropriate for a medico-legal documentation as the note is filled out. By processing the text correctly, presenting the text it a note format that requires minimal post-production editing, the need for direct data entry or separate dictation to document the visit is circumvented.

Using this partially completed note, the medical professional can ask additional questions to the patient. At step 118, the medical professional asks questions related to the ICD-10 billing codes identified from the key terms. Similarly, at step 120, the medical professional asks questions which are related to the medical conditions identified from the key terms. For example, if “headaches” are identified from the key terms, the medical professional may ask questions to determine the causes, length, and intensity of the headaches. Depending on the key terms identified and the partially completed note, steps 118 and 120 may be performed together, alternatively, or multiple times, switching back and forth between the two. It is within the discretion of the medical professional to determine exactly how much to perform each of these steps based on the partially completed note.

At step 122, the patient responds to the additional questions that were asked by the medical professional. Like the other dialogue described above, the questions and answers are converted to text at step 124. Additional key text terms are then identified from the additional text at step 126. The additional key text terms can be identified in ways similar to the methods described with respect to the key text terms. For example, they additional key text terms can be identified by matching areas of the text with key terms from the database.

The partially completed note is then updated to include information related to the additional key text terms at step 128. At this point, the medical professional reviews the note and determines whether more information is needed. At step 130, if more information is needed, the previous steps can be repeated until the note has been filled out. In particular, steps 118-128 can be repeated to continue updating the note with additional information.

At step 132, the partially completed note is reviewed, preferably by the medical professional, for errors. If errors are found, the medical professional can modify the note accordingly. Once the medical professional feels that the note has accurately captured the visit and is complete from a medical documentation and billing standpoint, the note can be approved at step 134. Approval of the note may include, for example, signing and filing the note. Once the note is approved, a final medical record exists that is appropriately phrased and formatted and suitable for medico-legal documentation in standard clinical terminology.

Finally, at step 136, the highest possible E&M level is calculated based on the completed medical record. E&M is a measure of visit complexity which a provider is required to report for every visit based on the amount of detail included in the documented evaluation when compared against the published standard Medicare E&M level assignment criteria. Therefore calculating E&M based on the completed medical note helps eliminate the risk of potential inaccuracy in the level assignment.

It is important to note that when key text terms are identified from the text, distinctions may be made between text related to questions asked by the provider and responses given by the patient. For example, if the provider asks “Have you been having headaches?”, the word “headaches” in this context should not be considered a key text. However, if the patient responds “Yes, I have been having headaches”, then the word “headache” would be considered a key text term (as long as it is in the database of key terms). In some cases, proofreading by the medical professional can weed out key text terms which should not have been identified as key text terms or which should not be included in the medical record. However, other processes can be employed as well.

For example, the dialogue text to conversion mechanism may use software to only convert dialogue to text that will be used to identify key text terms. In other cases, all of the dialogue may be converted and software may be used to ignore words that should not be considered key text terms because of their context. For example, if the patient responded to the medical providers question by saying “No, I have not had any headaches” then the word headache would not be considered a key text term even though the word headache may be in a database of key terms. Alternatively, the questions asked by the medical provided may not be converted into text at all, or ignored in determining key text terms. This can be accomplished through the use of software with a natural language parsing techniques. The natural language parsing technique allows only relevant key text terms to be identified, and also allows the note that is being created, and thus the eventual medical record, to mirror plain language.

By accomplishing this in real time during the visit, the provider's recorded speech is immediately converted into a medical note and is available to the provider before the note is finalized. The provider has the option of asking additional questions to the patient before the visit concludes, in order to revise the document for clarification of these points or to justify a higher coding and billing level if appropriate. The result ensures the accuracy and completeness of the final medical record, ensures full billing revenue, and can save time for the medical provider. The provider also receives immediate feedback which can help improve the provider's own future thoroughness in eliciting information in subsequent patient encounters.

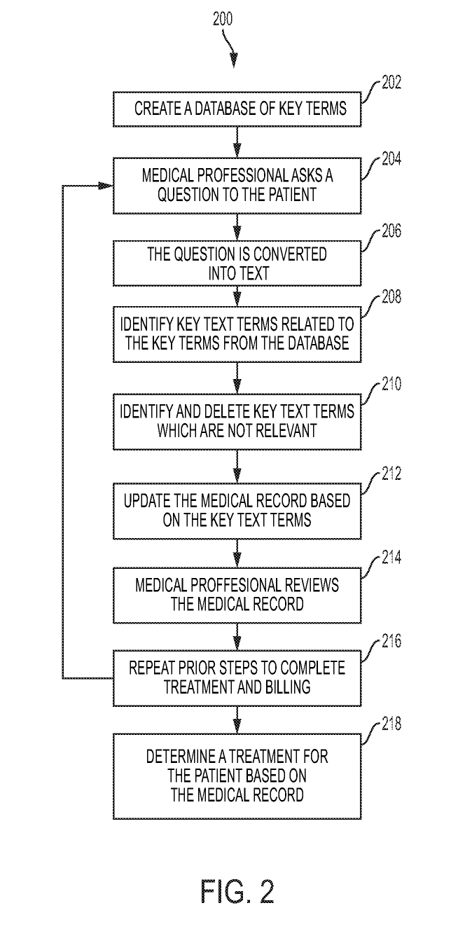

Referring now to FIG. 2, another process in accordance with the subject technology of creating a medical record to document a meeting between a patient and a medical professional is shown generally at 200. The process 200 begins at step 202 with creating a database of key terms related to one or more of the following categories: ICD-10 billing codes; medical conditions; treatment; or diagnoses.

At step 204, the medical professional asks a question to the patient. The question is then converted into text at step 206. Notably, in this process 200, only the medical professional's question is converted to text at step 206. This text will ultimately be relied upon to create the medical record. Therefore the onus is on the medical professional to ask appropriate questions such that text is generated related to the patient's conditions, their treatment, the diagnoses, and other relevant areas.

At step 208, a number of key text terms are identified from the text. In general, the key text terms are determined from text that matches one of the key terms in the database. However, not all matches are automatically considered key text terms. As described above, various techniques, such as a natural language parsing program, can be employed to rely on the surrounding context of various words in the text to determine which words from the text that match key terms should identified as key text terms. To that end, the process of narrowing down the correct key text terms can be further improved, at step 210, by running the text through a computer program to determine which key terms are not relevant and delete them. Deleting the key text terms means that those deleted terms will no longer be considered as germane to process of treating the patient and documenting the medical visit.

Therefore, at step 212, a medical record for the patient is updated based on the key text terms that are still remaining and have not been deleted. As described above, the medical record may be a form medical record template that is filled in. Additionally, or alternatively, natural language parsing language may also be relied upon to such that the medical record is updated in a way that reflects natural written or spoken language. In some cases, the medical record includes a problem list and updating the medical record includes updating the problem list with corresponding key text terms. This is all done in real time as the medical professional meets with the patient. Further, the medical record is available for the medical professional to review, for example, on a computer screen, as the provider is treating the patient. Therefore at step 214, the medical professional reviews the medical record while the patient is still being treated. Based on his review, the medical professional determines whether the medical record is complete. At step 216, if additional information is required, steps 202-214 are repeated until all information required to complete the medical record has been obtained. After the medical record is complete, optionally, the medical professional may determine a treatment for the patient based on the medical record.

This subject process may also be part of an overall system as shown in U.S. Patent Publication No.: US 2007/0038471 A1 to Meisel et al., filed on Oct. 21, 2003, which is incorporated herein by reference. The hardware, computer, servers, databases, and devices may include particular user-features such as buttons, scanners and card readers, whether virtual or hard, that are specific to accomplish an aspect of the subject technology.

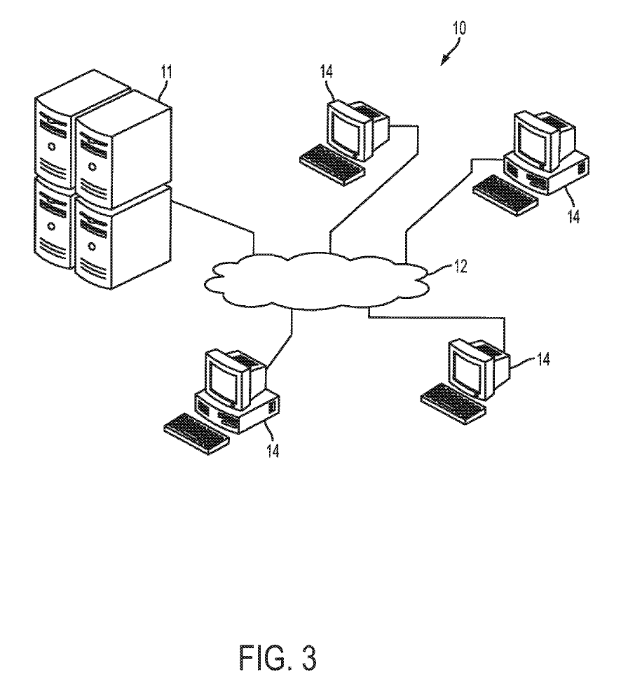

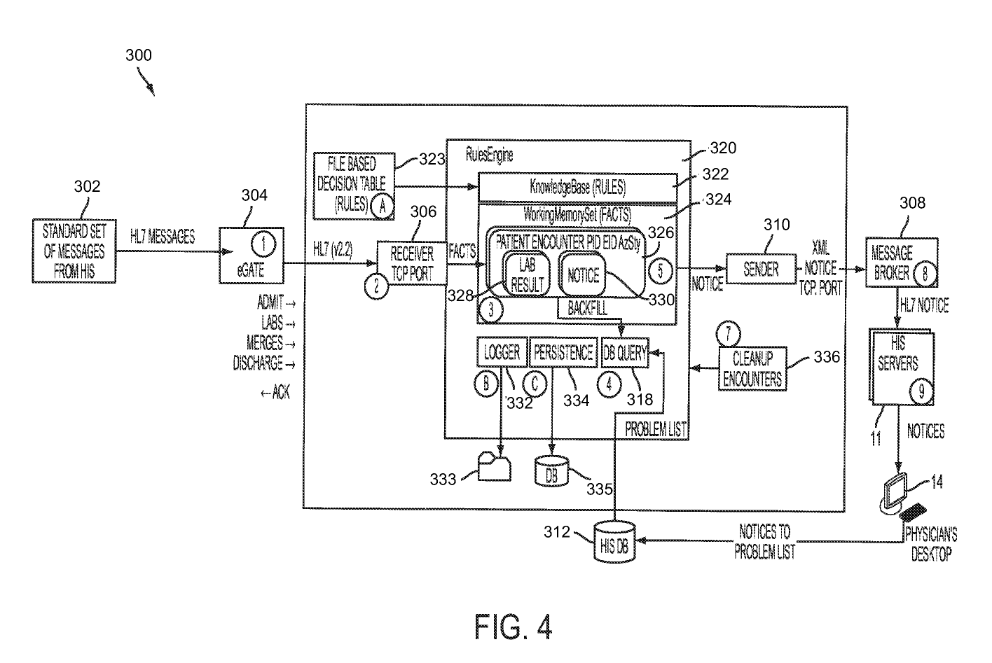

This subject process may also be part of an overall system as shown in FIG. 3 (a diagram showing a distributed computing environment for utilizing methods in accordance with the subject disclosure) and FIG. 4 (an exemplary hardware particularly configured to perform a process in accordance with the subject technology).

Referring now to the FIG. 3, there is shown a block diagram of an environment 10 that may embody and implement the methodology of the present disclosure. The following discussion describes the structure of such an environment 10. The environment may be application specific, unique and/or dedicated hardware suited and configured to accomplish the subject technology. The users may be clinicians or other caregivers, medical professionals, staff, medical coders and the like.

The environment 10 includes one or more servers 11 which communicate with a distributed computer network 12 via communication channels, whether wired or wireless, as is well known to those of ordinary skill in the pertinent art. In a preferred embodiment, the distributed computer network 12 is the Internet. For simplicity, although a plurality of servers 11 are shown, the term server 11 applies well to the grouping as such computing power is well-known to be aggregated. Server 11 hosts multiple websites and houses multiple databases necessary for the proper operation of the central monitoring methods in accordance with the subject technology.

The server 11 is any of a number of servers known to those skilled in the art that are intended to be operably connected to a network so as to operably link to a plurality of clients or user computers 14 via the distributed computer network 12. The plurality of computers or clients 14 may be desktop computers, laptop computers, personal digital assistants, tablet computers, scanner devices, cellular telephones and the like. The clients 14 allow users to enter and access information on the server 11. For simplicity, only four clients 14, 16 are shown but the number and location are unlimited. The clients 14 have displays and an input device(s) as would be appreciated by those of ordinary skill in the pertinent art.

It is understood that each of the devices 11, 14 of the environment 10 include a processor, memory storing executable code and other interconnected hardware to accomplish the functions and goals of the subject technology. Additionally, the hardware and software of the devices 11, 14 can be particularly configured and programmed to be particularly suitable for the purposes of the subject technology. For example in the environment 10, the servers 11 would store rules and program modules that can employ other rules (e.g., a business rules engine and its components). The servers 11 would also receive, store and send the necessary information including, without limitation, a rules database, tables of code data, and tables of patient data and the like. The servers 11 and devices 14 may include particular user-features such as buttons and card readers, whether virtual or hard, that are specific to accomplish an aspect of the subject technology.

The environment 10 also provides for administration and security maintenance. Therefore, although each user (e.g., data managers, medical coders, caregivers, clinicians, nurses, staff etc.) of the subject technology has access to a user interface on a client 14, each group's access is controlled. The interface specifies which aspects of the program can be accessed, and at what level in order to maintain compliance with technical electronic data interchange standards and legal confidentiality restraints such as HIPAA (Health Insurance Portability and Accountability Act) and quality standards such as GCP (Good Clinical Practice). Such limitations of functionality are well known to those skilled in the art and therefore not further described herein.

The process disclosed herein may be embodied in computer program software for execution on a computer, digital processor, microprocessor, generic devices 11, 14, and/or uniquely tailored devices 11, 14 in the environment 10. Those skilled in the art will appreciate that the process may include logic circuits on an integrated circuit that function according to the inventive technology. As such, the present technology may be practiced by a machine component that renders the program code elements in a form that instructs a digital processing apparatus (e.g., computer or hardware device) to perform a sequence of functional steps similar to or corresponding to those shown in the flow charts.

Referring now to FIG. 4, exemplary hardware is shown particularly configured to perform a process in accordance with the subject technology. The exemplary hardware can be implemented within environment 10 as would be appreciated upon review of the subject disclosure. A healthcare device 300 is present in the environment. The healthcare device 300 may be a single client processing device specially adapted for the purpose or portion of the healthcare device 300 may also be present on other hardware. In any case whether stand-alone or distributed, implementation of the healthcare device 300 may be executed differently based upon constraints such budget, processing, speed, ease-of-use and the like.

The healthcare device 300 receives information from a healthcare information system (HIS) 302. The HIS 302 provides a standard set of messages 304 such as admission information, laboratory information, discharge information. Preferably, the healthcare device 300 has a port 306 in communication with the HIS 302 and provides acknowledgement of the received information.

Still referring to FIG. 4, the healthcare device 300 also provides information to the HIS 302 via a message broker system 308 and HIS servers 11 that ultimately reaches the physician's desktop 14. Preferably, the healthcare device 300 has a sender subsystem 310 in communication with the message broker 308. The information sent to the physician's desktop 14 includes a Problem List among other information like notices for the Problem List that is also stored in the database 312 of the HIS servers 11. The healthcare device 300 also communicates with the HIS database 312 to keep the Problem List up to date via a query subsystem 318.

The healthcare device 300 includes a rules engine 320 that applies knowledge based rules stored in a rules database 322. A file based decision table 323 provides rules related input to the rules database 322. The knowledge based rules are applied to the factual information stored in a facts database 324. The facts database 324 includes all of the patient encounter data 326 such as lab results data 328 and notice data 330. The rules engine 320 also includes a logger module 332 for maintaining files 333 and a persistence module 334 for maintaining a real-time clinical data warehouse database 335 of information as needed. The healthcare device 300 also has a cleanup module 336 for housecleaning tasks and the like.

The healthcare device 300, and the components thereof, performs a number of important functions with respect the subject technology. For example, the healthcare device 300 can provide text conversion and key text term selection with natural language parsing, as described above. By using natural language parsing, only key text terms which actually relate to the medical treatment received are taken converted to text and/or relied upon. This way the medical record is devoid of terms that were mentioned in the dialogue during treatment but were ultimately not related to an actual condition, symptoms, etc. of the patient. Similarly, the healthcare device 300 can help assemble the key text terms into a coherent final medical record. For example, the healthcare device 300 can include modules that rely on the text of the dialogue between the patient and the healthcare professional to build a medical record that associates the key text terms with appropriate contextual language. In this way, the final medical record that is created will include the key text terms and the key text terms will exist in sentences or phrases that read like natural written and/or spoken language. Therefore the healthcare device 300 helps build a final medical record that, in many cases, requires little editing or modification from the healthcare professional.

It will be appreciated by those of ordinary skill in the pertinent art that the functions of several elements may, in alternative embodiments, be carried out by fewer elements, or a single element. All processes shown and described herein, in different embodiments, may be carried out by executing the steps in a different order, or by omitting a step or adding additional steps.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

1. A process of generating an appropriately phrased and formatted final medical record suitable for medico-legal documentation in standard clinical terminology comprising:
(I)(a) creating a dialogue between a medical professional and a patient by the medical professional asking a plurality of questions to the patient and the patient providing a plurality of responses;
(II) converting the dialogue into text;
(III) identifying at least one key text term from the text;
(IV) identifying at least one ICD-10 billing code which corresponds to the at least one key text term;
(V) creating a partially completed note from the key text terms;
(VI) asking at least one additional question to the patient based on the at least one ICD-10 billing codes;
(VII) receiving at least one additional response from the patient to the at least one additional question; and
(VIII) converting the additional questions and additional responses into additional text;
(IX) identifying additional key text terms from the additional text; and
(X) updating the partially completed note by adding information related to the additional key text terms to the partially completed note.

2. The process of claim 1 further comprising the steps of:
(IV)(a) identifying at least one medical condition related to the at least one key text term;
(VI)(a) asking at least one medical condition question to the patient based on the at least one medical condition;
(VII)(a) receiving at least one medical condition response from the patient to the at least one medical condition question; and
(VIII) (a) converting the at least one medical condition question and the at least one medical condition response into additional text.

3. The process of claim 1 further comprising:
(XI) repeating steps (VI)-(X) depending on whether the additional text corresponds to at least one additional ICD-10 billing codes.

4. The process of claim 2 further comprising:
(XII) repeating steps (VI)(a), (VII)(a), (VIII)(a), (IX), (X) depending on whether the additional text corresponds to at least one new medical condition.

5. The process of claim 4 wherein in step (V) the partially completed note is created from the text by entering data terms related to the at least one key text terms, the at least one ICD-10 billing codes, and the at least one medical condition into a standard medical record form.

6. The process of claim 5 further comprising:
(I) providing a database containing a plurality of key terms related to ICD-10 billing codes and medical conditions.

7. The process of claim 6 wherein in step (III) the key text terms are identified by comparing the text with the key terms of the database.

8. The process of claim 7 wherein in step (IX) the additional key text terms are identified by comparing the additional text with the key terms of the database.

9. The process of claim 8 further comprising:
(XIII) proofreading the partially completed note for errors; and
(XIV) approving the partially completed note to create a completed medical record.

10. The process of claim 9 further comprising:
(XV) Calculating the highest allowable E&M level.

11. A process of creating a medical record to document a meeting between a patient and a medical professional comprising:
(I) the medical professional asking a question to the patient;
(II) the patient providing a response to the question;
(III) converting the question and the response into text;
(IV) identifying at least one key text term from the text related to one of the following: ICD-10 billing codes; or medical conditions;
(V) updating the medical record based on the key text terms;
(VI) the medical professional reviewing the medical record; and
(VII) repeating steps (I) through (VI) until the medical professional determines that no additional information is required.

12. The process of claim 11 wherein the medical record includes a problem list and step (V) includes updating the problem list based on the key text terms.

13. The process of claim 12 further comprising:
(VIII) reviewing the medical record;
(IX) updating the medical record based on any errors or omissions; and
(X) determining a treatment for the patient based on the completed medical record.

14. A process of creating a medical record to document a meeting between a patient and a medical professional comprising:
(I) creating a database of key terms related to one or more of the following: ICD-10 billing codes; medical conditions; treatment; or diagnoses;
(II) the medical professional asking a question to the patient;
(III) converting the question into text;
(IV) identifying a number of key text terms from the text by determining which words from the text match key terms from the database;
(V) updating the medical record based on the key text terms;
(VI) reviewing, by the medical professional, the medical record; and
(VII) repeating steps (II) through (VI) until the medical professional determines that no additional information is required to complete the medical record.

15. The process of claim 14 wherein the medical record includes a problem list and step (V) includes updating the problem list based on the key text terms.

16. The process of claim 15 further comprising:
(VIII) determining a treatment for the patient based on the medical record.

17. The process of claim 16 further comprising:
(V)(a) running the text through a computer program to identify and delete key text terms which are not relevant.
